(19) United States
(12) Patent Application Publication
(10) Pub. No.: US 2020/0402206 A1
(43) Pub. Date: Dec. 24, 2020

(54) IMAGE PROCESSING DEVICE, IMAGE PROCESSING METHOD, AND PROGRAM

(71) Applicant: SONY CORPORATION, TOKYO (JP)

(72) Inventors: HIDEYUKI ICHIHASHI, TOKYO (JP); TOMOHIRO NISHI, TOKYO (JP); YIWEN ZHU, KANAGAWA (JP); MASATOSHI YOKOKAWA, KANAGAWA (JP)

(21) Appl. No.: 16/975,358

(22) PCT Filed: Nov. 28, 2018
(86) PCT No.: PCT/JP2018/043712

§ 371 Date: Aug. 24, 2020

(30) Foreign Application Priority Data
Mar. 1, 2018 (JP) 2018-036248

(51) Int. Cl. G06T 3/40; G06T 5/00; G06T 7/00; G06T 7/20; H04N 5/232

(52) U.S. Cl. CPC G06T 3/4053; G06T 3/4038; G06T 5/006; H04N 5/23296; G06T 7/20; H04N 5/23238; G06T 7/0002

(57) ABSTRACT

With a wide angle-of-view image acquired by an image pickup unit 21-1 as a reference, a signal processing unit 30 performs super-resolution processing by using a plurality of narrow angle-of-view images acquired by an image pickup unit 21-2 that uses a lens having a higher MTF (Modulation Transfer Function) than the image pickup unit 21-1. A control unit 60 controls the signal processing unit 30 so as to select an image having a range of angle of view according to a zoom magnification indicated by user's operation from the image subjected to the super-resolution processing. In the super-resolution processing, according to a detection result of parallax from a narrow angle-of-view image and the wide angle-of-view image acquired at the same time and a motion detection result for each of the plurality of narrow angle-of-view images, parallax compensation and motion compensation are performed on the plurality of narrow angle-of-view images. A captured image beyond the performance of the image pickup unit can be acquired.

### TECHNICAL FIELD

This technique relates to an image processing device, an image processing method, and a program, and enables a zoom operation to be performed seamlessly from a wide-angle view to a telephoto view without degrading image quality.

### BACKGROUND ART

In the past, in an information processing terminal such as a portable electronic device like a smartphone, due to downsizing and thinning, the image quality of an image pickup unit is lower than that of a single-lens reflex camera or the like. For this reason, for example, PTL 1 discloses that a plurality of image pickup units is provided to simultaneously generate a plurality of images having different image qualities such as images of a first angle of view and a second angle of view narrower than the first angle of view.

### CITATION LIST

### Patent Literature

[PTL 1]
JP 2013-219525 A

### SUMMARY

### Technical Problem

Meanwhile, a captured image that exceeds the performance of the image pickup unit cannot be acquired simply by providing a plurality of image pickup units as in PTL 1.

Therefore, an object of this technology is to provide an image processing device, an image processing method, and a program that enable a captured image that exceeds the performance of the image pickup unit to be acquired.

### Solution to Problem

A first aspect of this technology is an image processing device including a signal processing unit that performs super-resolution processing using a plurality of narrow angle-of-view images having a narrow angle of view within a range of an angle of view of a wide angle-of-view image, with the wide angle-of-view image as a reference.

In this technique, the signal processing unit performs super-resolution processing, with a wide angle-of-view image (for example, color image) acquired by the first image pickup unit as a reference, by using a plurality of narrow angle-of-view images (for example, black-and-white images) acquired by a first image pickup unit using a lens having a higher MTF (Modulation Transfer Function) than that of the first image pickup unit, that is, using images having a narrow angle-of-view within the angle of view of the wide angle-of-view image. The super-resolution processing uses images of the region of interest set in the wide angle-of-view image and the narrow angle-of-view image according to the zoom magnification.

The control unit controls the signal processing unit so as to select an image in the range of angle of view corresponding to the zoom magnification indicated by the user operation from the image after the super-resolution processing. Further, the signal processing unit extracts an image in the range of angle of view corresponding to the zoom magnification from the wide angle-of-view image at the time of preview.

In the super-resolution processing, parallax compensation and movement compensation are performed on a plurality of narrow angle-of-view images according to a parallax detection result from the wide angle-of view image and the narrow angle-of-view image acquired at the same time and a movement detection result for each of a plurality of narrow angle-of-view images.

Moreover, the signal processing unit may use a plurality of wide angle-of-view images in the super-resolution processing. In this case, the parallax is detected from the wide angle-of-view image and the narrow angle-of-view image acquired at the same time, and the movement of the plurality of wide angle-of-view images is detected, and parallax compensation and movement compensation are performed on a plurality of narrow angle-of-view images according to the detection result, regarding the movement of the plurality of narrow angle-of-view images as the movement of the wide angle-of-view image at the same time, and movement compensation is performed on a plurality of wide angle-of-view images according to the detection result, in the super-resolution processing.

A second aspect of this technology is a method for processing an image including performing super-resolution processing using a plurality of narrow angle-of-view images that have an angle of view which is narrower than that of a wide angle-of-view image and within a range of an angle of view of the wide angle-of-view image, with the wide angle-of-view image as a reference, by using a signal processing unit.

A third aspect of this technology is a program that causes a computer to execute processing of an image generated by an image pickup unit, the processing including

acquiring a wide angle-of-view image, and

performing super-resolution processing using a plurality of narrow angle-of-view images that have an angle of view which is narrower than that of the wide angle-of-view image and within a range of an angle of view of the wide angle-of-view image, with the wide angle-of-view image as a reference.

### Advantageous Effect of Invention

According to this technique, super-resolution processing is performed using a plurality of narrow angle-of-view images having a narrow angle of view within the range of angle of view of the wide angle-of-view image, with the wide angle-of-view image as a reference. Therefore, a captured image that exceeds the performance of the image pickup unit can be acquired. It should be noted that the effects described in the present specification are merely examples and the effect is not limited thereto and may have additional effects.

### BRIEF DESCRIPTION OF DRAWINGS

FIG. 1 depicts diagrams each illustrating an external appearance of a device to which an image processing device is applied.

FIG. 2 is a diagram illustrating a configuration of an information processing terminal.

FIG. 3 is a diagram illustrating imaging areas.

FIG. 4 depicts diagrams illustrating pixel arrays of image pickup units.

FIG. 5 is a diagram illustrating a configuration of a first embodiment.

FIG. 6 is a diagram illustrating a configuration of a super-resolution processing section.

FIG. 7 is a flowchart depicting the operation of the first embodiment.

FIG. 8 depicts diagrams each depicting an operation example of the first embodiment.

FIG. 9 is a diagram illustrating a configuration of a second embodiment.

FIG. 10 is a flowchart depicting an operation of the second embodiment.

FIG. 11 depicts diagrams each depicting an operation example of the second embodiment.

FIG. 12 depicts diagrams each illustrating spectrum distribution.

FIG. 13 is a block diagram depicting an example of schematic configuration of a vehicle control system.

FIG. 14 is a diagram of assistance in explaining an example of installation positions of an outside-vehicle information detecting section and an imaging section.

### DESCRIPTION OF EMBODIMENTS

Hereinafter, modes for carrying out the present technology will be described. Incidentally, the description will be given in the following order.

1. Configuration of a device to which an image processing device is applied

2. Embodiment of the image processing device
2-1. Configuration of a first embodiment
2-2. Operation of the first embodiment
2-3. Configuration of a second embodiment
2-4. Operation of the second embodiment
2-5. Third embodiment
2-6. Other embodiments

3. Application example

### 1. Configuration of Device to which Image Processing Device is Applied

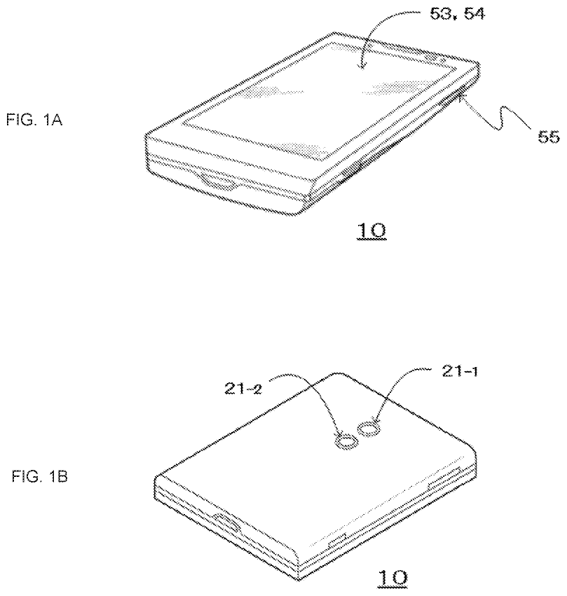

FIG. 1 illustrates an external appearance of a device to which an image processing device according to this technique is applied. Note that, in the following description, the image processing device is applied to the information processing terminal, for example. A subfigure (a) of FIG. 1 depicts the front side of an information processing terminal 10, and a display unit 53, a touch panel 54, and an operation unit 55 are provided on the front side. A subfigure (b) of FIG. 1 depicts the back side of the information processing terminal 10, and a plurality of image pickup units, for example, two image pickup units 21-1 and 21-2 are provided on the back side.

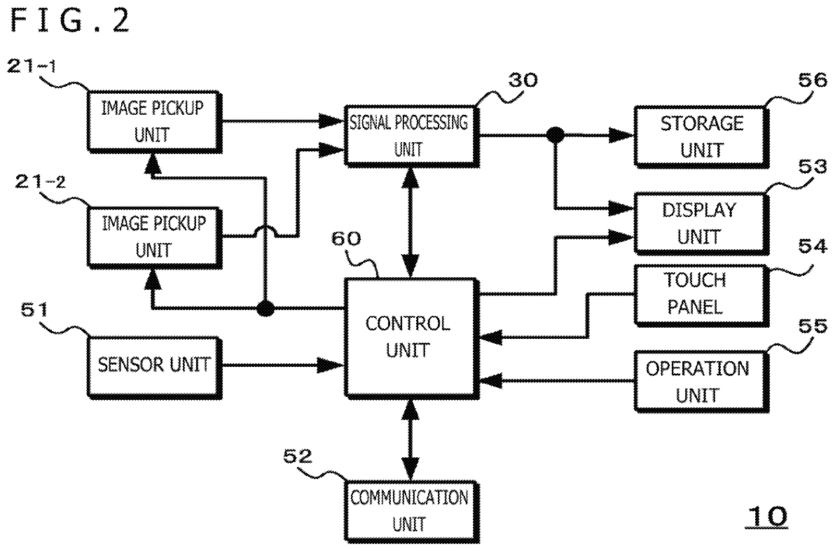

FIG. 2 illustrates the configuration of the information processing terminal. The information processing terminal 10 includes a plurality of image pickup units, for example, the two image pickup units 21-1 and 21-2, a signal processing unit 30, a sensor unit 51, a communication unit 52, the display unit 53, the touch panel 54, the operation unit 55, and a storage unit 56, and a control unit 60. The signal processing unit 30 constitutes an image processing device of this technology.

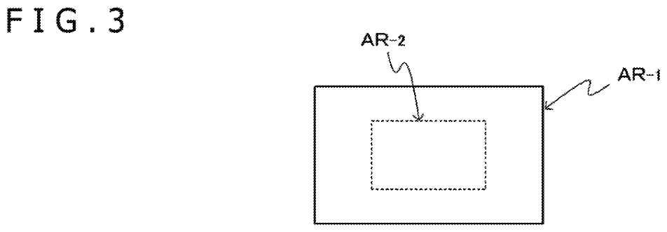

The image pickup units 21-1 and 21-2 are provided on the same surface side of the information processing terminal 10 as depicted in the subfigure (b) of FIG. 1. The image pickup units 21-1 and 21-2 are configured by using an imaging element such as a CMOS (Complementary Metal Oxide Semiconductor) image sensor, and perform photoelectric conversion of light taken in by a lens (not illustrated), thereby generating the image data of the captured images to output the data to the signal processing unit 30. Further, the image pickup units 21-1 and 21-2 have characteristic differences, the image pickup unit 21-1 has a wider angle of view than the image pickup unit 21-2, and the image pickup unit 21-2 has higher quality for images than the image pickup unit 21-1. Moreover, the imaging area of the image pickup unit 21-2 is configured to be included in the imaging area of the image pickup unit 21-1. FIG. 3 illustrates imaging areas, and an imaging area AR-2 of the image pickup unit 21-2 is configured to be located at the center of an imaging area AR-1 of the image pickup unit 21-1. Incidentally, in the following description, the captured image acquired by the image pickup unit 21-1 is referred to as a wide angle-of-view image, and the captured image acquired by the image pickup unit 21-2 is referred to as a narrow angle-of-view image.

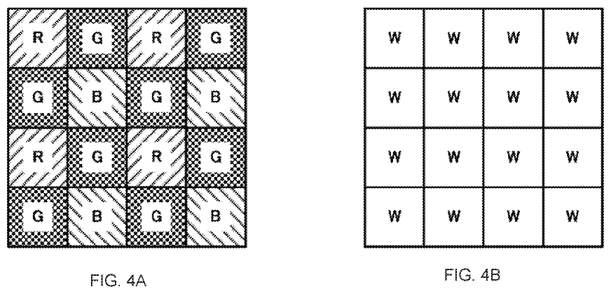

FIG. 4 illustrates pixel arrays of the image pickup units. A subfigure (a) of FIG. 4 depicts the pixel array of the image pickup unit 21-1. The image pickup unit 21-1 is configured using a color filter in which red (R) pixels, blue (B) pixels, and green (G) pixels are arranged in a Bayer array, for example. In the Bayer array, in a pixel unit of 2×2 pixels, two pixels at diagonal positions are green (G) pixels, and the remaining pixels are a red (R) pixel and a blue (B) pixel. That is, the image pickup unit 21-1 is so configured that the pixel array depicted in the subfigure (a) of FIG. 4 is repeated and each pixel outputs an electric signal based on the incident light amount of any one of the color components of red, blue, or green. Therefore, the image pickup unit 21-1 generates image data of a color captured image in which each pixel indicates one of the three primary color (RGB) components.

A subfigure (b) of FIG. 4 depicts the pixel array of the image pickup unit 21-2. In the image pickup unit 21-2, the pixel array depicted in the subfigure (b) of FIG. 4 is repeated, and each pixel is configured as a W (white) pixel that outputs an electric signal based on the amount of incident light in all wavelength regions of visible light. Therefore, the image pickup unit 21-2 generates image data of black-and-white captured images. Note that the image pickup unit 21-2 is not limited to the case of generating image data of black-and-white images as image data of captured images having higher image quality than that of the image pickup unit 21-1 and may generate image data of color images.

The signal processing unit 30 performs super-resolution processing, with a wide angle-of-view image acquired by the image pickup unit 21-1 as a reference, by using a plurality of narrow angle-of-view images acquired by the image pickup unit 21-2, that is, a plurality of narrow angle-of-view images having a narrow angle of view within the range of angle of view of the wide angle-of-view image. Further, the signal processing unit 30 uses an image in the range of angle of view corresponding to the zoom magnification from the image after the super-resolution processing to generate a seamless zoom image from a wide-angle view to a telephoto view, and outputs the image to the display unit 53 and the storage unit 56. Incidentally, the details of the configuration and operation of the signal processing unit 30 will be described later.

The sensor unit 51 is configured by using a gyro sensor or the like, and detects a shake generated to the information processing terminal 10. The sensor unit 51 outputs information regarding the detected shake to the control unit 60.

The communication unit 52 communicates with devices on a network such as a LAN (Local Area Network) or the Internet.

The display unit 53 displays a captured image on the basis of image data supplied from the signal processing unit 30, and displays a menu screen, various application screens, and the like on the basis of information signals from the control unit 60. Further, the touch panel 54 is mounted on the display surface side of the display unit 53 and configured such that the GUI function can be used.

The operation unit 55 is configured using operation switches and the like and generates operation signals according to a user operation and outputs the operation signals to the control unit 60.

The storage unit 56 stores information generated by the information processing terminal 10, for example, image data supplied from the signal processing unit 30 and various types of information used for executing communication and applications in the information processing terminal 10.

The control unit 60 includes a CPU (Central Processing Unit), a ROM (Read Only Memory), a RAM (Random Access Memory) (not illustrated), and the like. The control unit 60 executes the programs stored in the ROM or the RAM and controls the operation of each part such that the information processing terminal 10 performs operation corresponding to a user operation on the user interface unit, which is the touch panel 54 or the operation unit 55. In addition, the control unit 60 generates information regarding the user operation, for example, zoom information indicating a zoom magnification set by the user or the like and outputs the information to the signal processing unit 30.

It should be noted that the information processing terminal 10 is not limited to the configuration depicted in FIG. 2, and for example, may be provided with an encoding processing unit configured to encode image data to store the encoded image data in the storage unit 56, a resolution converting unit that adjusts the image data to the resolution of the display unit, and the like.

### 2. Embodiment of Image Processing Device

### 2-1. Configuration of First Embodiment

In the first embodiment, a case will be described in which, with a color captured image acquired by the image pickup unit 21-1 as a reference, super resolution is performed using this color captured image and a plurality of frames of black-and-white captured images acquired by the image pickup unit 21-2 to generate a high-resolution color image.

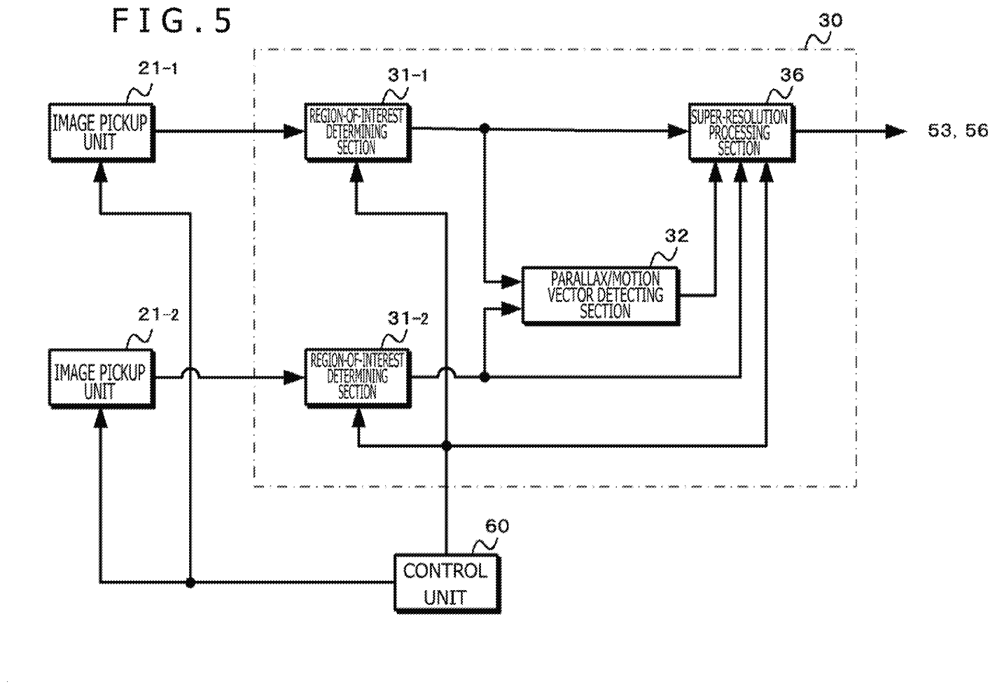

FIG. 5 illustrates the configuration of the first embodiment. The signal processing unit 30 includes region-of-interest (RIO) determining sections 31-1 and 31-2, a parallax/motion vector detecting section 32, and a super-resolution processing section 36.

The region-of-interest (RIO) determining section 31-1 determines an area necessary for display (region of interest) in a wide angle-of-view color captured image acquired by the image pickup unit 21-1 on the basis of the zoom magnification indicated from the control unit 60. The region-of-interest determining section 31-1 outputs a color image Ic1t0 of the region of interest to the parallax/motion vector detecting section 32 and the super-resolution processing section 36.

The region-of-interest (RIO) determining section 31-2 determines an area necessary for display (region of interest) in the plurality of frames of black-and-white captured images acquired by the image pickup unit 21-2 on the basis of the zoom magnification indicated from the control unit 60. The region-of-interest determining section 31-2 outputs black-and-white images Ic2t0 to Ic2tn of the region of interest to the parallax/motion vector detecting section 32 and the super-resolution processing section 36.

By setting the regions of interest in the region-of-interest determining sections 31-1 and 31-2 in this manner, the super-resolution processing to be described later can be performed more efficiently than the case where the super-resolution processing using the entire image is performed.

The parallax/motion vector detecting section 32 detects the parallax of the image pickup unit 21-2 with respect to the image pickup unit 21-1 from the image of the region of interest determined by the region-of-interest determining section 31-1 and the image of the region of interest determined by the region-of-interest determining section 31-2. Further, with respect to the plurality of frames of images of the region of interest determined by the region-of-interest determining section 31-2, a motion vector based on the image acquired by the image pickup unit 21-1 is detected. The parallax/motion vector detecting section 32 outputs the detected parallax and motion vector to the super-resolution processing section 36.

The super-resolution processing section 36 performs super-resolution processing using a plurality of narrow angle-of-view images acquired by the image pickup unit 21-2 having a narrower angle of view than the image pickup unit 21-1 within the range of angle of view of the image pickup unit 21-1, with the wide angle-of-view image acquired by the image pickup unit 21-1, which has a wider angle of view than the image pickup unit 21-2 as a reference. In the super-resolution processing, a high-resolution image is generated by additively feeding back a plurality of low-resolution images at different times.

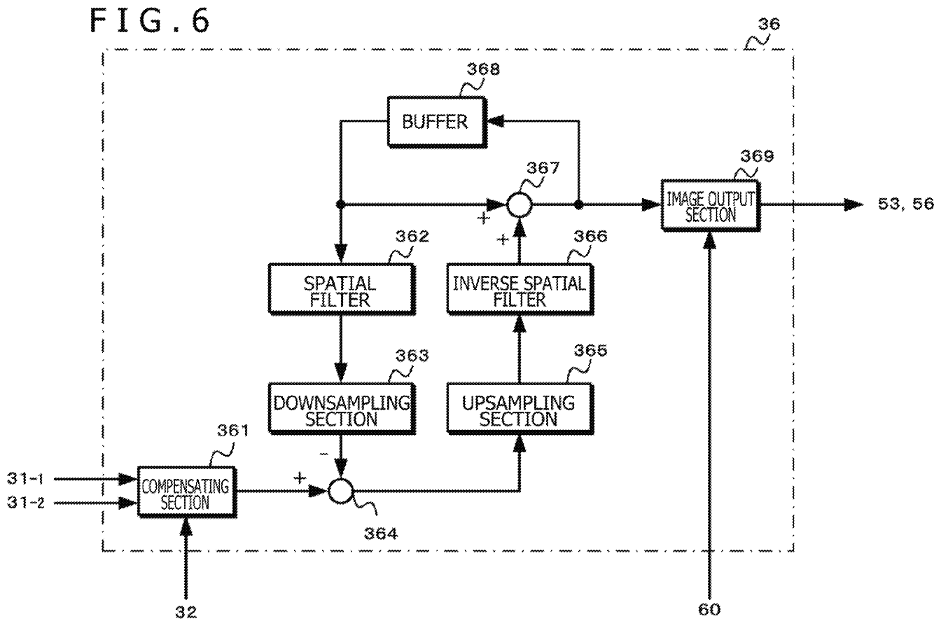

FIG. 6 illustrates the configuration of the super-resolution processing section. The super-resolution processing section 36 includes a compensating section 361, a spatial filter 362, a downsampling section 363, a subtracting section 364, an upsampling section 365, an inverse spatial filter 366, an adding section 367, a buffer 368, and an image output section 369.

The compensating section 361 outputs the color captured image to be a reference to the subtracting section 364. Further, the compensating section 361 performs parallax compensation and motion compensation on the plurality of frames of monochrome captured images on the basis of the detection result of the parallax/motion vector detecting section and outputs the images to the subtracting section 364.

The spatial filter 362 performs a process of simulating deterioration of spatial resolution on the image stored in the buffer 368. Here, the point spread function measured beforehand is used as a filter to apply convolution to the image.

The downsampling section 363 performs downsampling processing on the image supplied from the spatial filter 362 to the same resolution as the monochrome image of the region of interest.

The subtracting section 364 subtracts the image from the downsampling section 363 from the image from the compensating section 361 for each pixel to generate a difference image. The subtracting section 364 outputs the generated difference image to the upsampling section 365.

The upsampling section 365 converts the difference image supplied from the subtracting section 364 to an image having the same resolution as that before downsampling performed in the downsampling section 363, which is higher than that of the color captured image or the monochrome captured image of the region of interest, and outputs the image to the inverse spatial filter 366.

The inverse spatial filter 366 performs a filter processing having a characteristic opposite to that of the spatial filter 362 on the difference image supplied from the upsampling section 365 and outputs the filtered difference image to the adding section 367.

The adding section 367 adds the image stored in the buffer 368 to the difference image output from the inverse spatial filter 366 and outputs the result to the buffer 368 and the image output section 369.

The buffer 368 stores the image supplied from the adding section 367. In addition, the buffer 368 outputs the stored image to the spatial filter 362 and the adding section 367.

The image output section 369 outputs an image in the range of angle of view corresponding to the zoom magnification set by the user or the like from the image after the super-resolution processing to the display unit 53, the storage unit 56, or the like, on the basis of the zoom information from the control unit 60 so as to perform a seamless zoom operation from a wide-angle view to a telephoto view.

### 2-2. Operation of First Embodiment

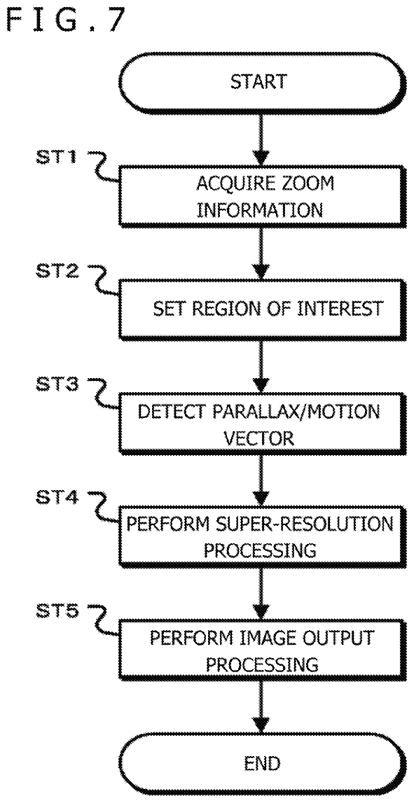

FIG. 7 is a flowchart depicting the operation of the signal processing unit according to the first embodiment. In step ST1, the signal processing unit acquires zoom information. The signal processing unit acquires the zoom information from the control unit 60 and proceeds to step ST2.

In step ST2, the signal processing unit sets a region of interest. The region-of-interest determining section 31-1 of the signal processing unit 30 determines the region of interest that is a region necessary for outputting an image of the zoom magnification indicated by the zoom information in the wide angle-of-view color captured image acquired by the image pickup unit 21-1. In addition, the region-of-interest determining section 31-2 determines the region of interest that is a region necessary for outputting the image of the zoom magnification indicated by the zoom information in the narrow angle-of-view monochrome image captured by the image pickup unit 21-2. The region-of-interest determining sections 31-1 and 31-2 determine the regions of interest, and the processing proceeds to step ST3.

In step ST3, the signal processing unit detects a parallax/motion vector. The parallax/motion vector detecting section 32 of the signal processing unit 30 detects the parallax of the image pickup unit 21-2 with respect to the image pickup unit 21-1, on the basis of the image of the region of interest determined by the region-of-interest determining section 31-1 and the image of the region of interest determined by the region-of-interest determining section 31-2. Further, the motion vector is detected for each of the plurality of frame images of the region of interest determined by the region-of-interest determining section 31-2, and the processing proceeds to step ST4.

In step ST4, the signal processing unit performs super-resolution processing. The super-resolution processing section 36 of the signal processing unit 30 performs super-resolution processing, with the color image as a reference, using this color captured image and a plurality of frames of black-and-white captured images, and generates a color image in which the resolution of the imaging area of the image pickup unit 21-2 has been made high and proceeds to step ST5.

In step ST5, the signal processing unit performs image output processing. The super-resolution processing section 36 of the signal processing unit 30 outputs an image in the range of angle of view corresponding to the zoom magnification set by the user or the like to the display unit 53, the storage unit 56, and the like from the image generated in step ST4, on the basis of the zoom information from the control unit 60.

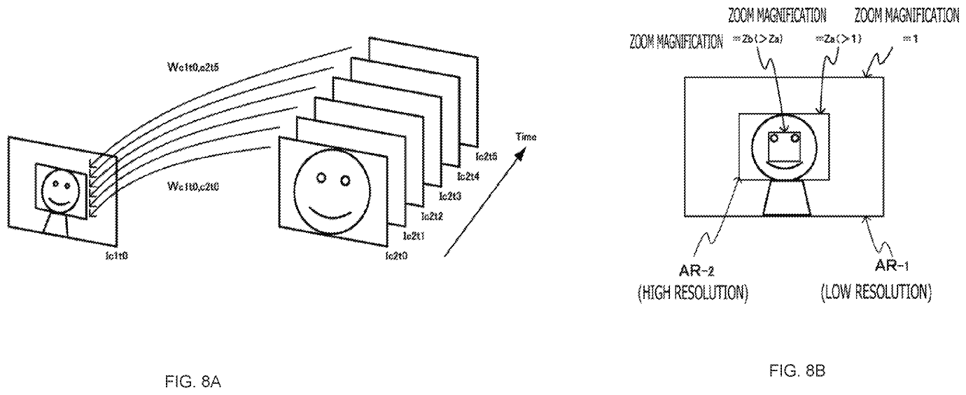

FIG. 8 depicts operation examples of the first embodiment. Incidentally, for the sake of simplifying the description, the region of interest is set to be the entire image. As depicted in a subfigure (a) of FIG. 8, the signal processing unit 30 performs super-resolution processing using the six monochrome images Ic2t0 to Ic2t5 acquired by the image pickup unit 21-2 while using the color image Ic1t0 acquired by the image pickup unit 21-1 as a reference, for example. Note that, in the super-resolution processing, position correction and addition feedback processing of the monochrome images Ic2t0 to Ic2t5 acquired by the image pickup unit 21-2 are performed on the basis of the parallax and motion vectors Wc1t0, c2t0 to Wc1t0, c2t5. Therefore, the imaging area AR-2 of the image pickup unit 21-2 has high resolution. That is, as depicted a subfigure (b) of in FIG. 8, when the zoom magnification is 1, a wide angle-of-view color image in which the resolution of the image in the imaging area AR-2 of the image pickup unit 21-2 has been made high is output. Further, a high resolution color image is output when the zoom magnification becomes higher and the zoom range is Za times, namely when the zoom range coincides with the imaging area AR-2 of the image pickup unit 21-2. Further, when the zoom magnification becomes Zb times that is higher than Za times, the image in the region corresponding to the zoom magnification is output from the area where the imaging area AR-1 of the image pickup unit 21-1 and the imaging area AR-2 of the image pickup unit 21-2 overlap. That is, since the image of the overlapping area of the imaging area of the image pickup unit 21-1 and the imaging area of the image pickup unit 21-2 is an image generated by the super-resolution processing, a color image having a higher resolution than that of the related art can be output.

Therefore, according to the first embodiment, the zoom operation can be performed seamlessly from a wide-angle view to a telephoto view without degrading the image quality.

### 2-3. Configuration of Second Embodiment

In the second embodiment, a case will be described in which a high-resolution color image is generated by super-resolution by using a plurality of frames of color images and a plurality of frames of monochrome images having different visual points.

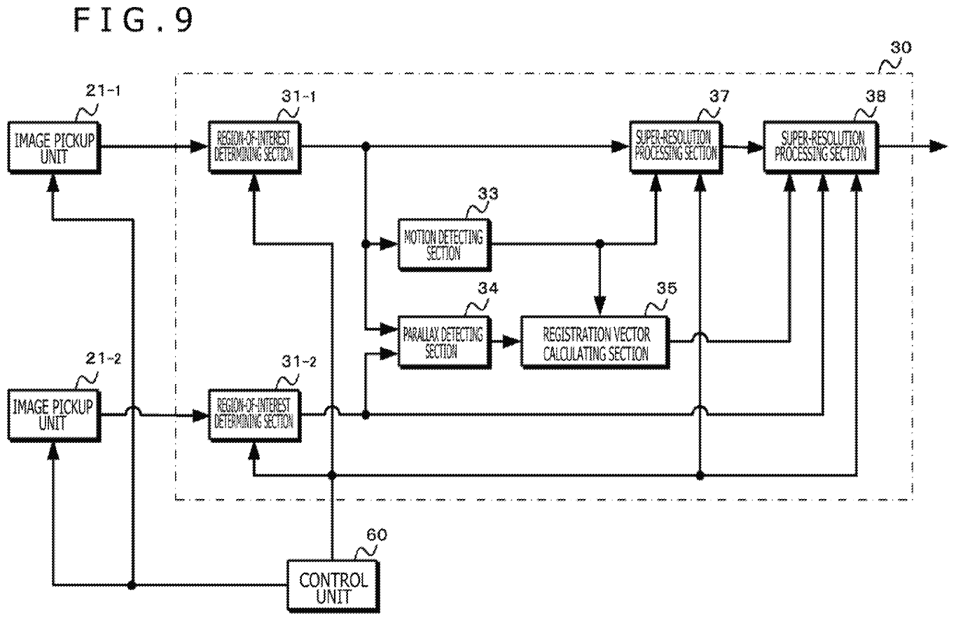

FIG. 9 illustrates the configuration of the second embodiment. The signal processing unit 30 includes region-of-interest (RIO) determining sections 31-1 and 31-2, a motion detecting section 33, a parallax detecting section 34, a registration vector calculating section 35, super-resolution processing sections 37 and 38.

The region-of-interest (RIO) determining section 31-1 determines the area required for display (region of interest) in the plurality of frames of color images having a wide angle of view acquired by the image pickup unit 21-1 on the basis of the zoom magnification indicated from the control unit 60. The region-of-interest determining section 31-1 outputs color images Ic1t0 to Ic1tn of the region of interest to the motion detecting section 33, the parallax detecting section 34, and the super-resolution processing section 37.

The region-of-interest (RIO) determining section 31-2 determines an area necessary for display (region of interest) in the plurality of frames of black-and-white captured images acquired by the image pickup unit 21-2 on the basis of the zoom magnification indicated from the control unit 60. The region-of-interest determining section 31-2 outputs monochrome images Ic2t0 to Ic2tn of the region of interest to the parallax detecting section 34 and the super-resolution processing section 38.

The motion detecting section 33 detects a motion vector for the color image Ic1t0 for each frame from the plurality of frames of images of region of interest determined by the region-of-interest determining section 31-1. The motion detecting section 33 outputs the detected motion vector to the registration vector calculating section 35 and the super-resolution processing section 37.

The parallax detecting section 34 detects the parallax of the image pickup unit 21-2 with respect to the image pickup unit 21-1 from the image of the region of interest determined by the region-of-interest determining section 31-1 and the image of the region of interest determined by the region-of-interest determining section 31-2. The parallax detecting section 34 detects the parallax on the basis of the color image Ic1t0 and the black-and-white image Ic2t0 of the region of interest, for example, and outputs the detected parallax to the registration vector calculating section 35.

The registration vector calculating section 35 calculates a motion vector in the spatiotemporal direction that adjusts the positions of the black-and-white images Ic2t0 to Ic2tn with respect to the color image Ic1t0 that is a reference. The registration vector calculating section 35 calculates the motion vector of each frame and outputs to the super-resolution processing section 38, with the monochrome images Ic2t0 to Ic2tn as the visual point of the image pickup unit 21-1, by using the motion vector detected by the motion detecting section 33 and the parallax detected by the parallax detecting section 34. Here, for the plurality of frames of black-and-white images Ic2t0 to Ic2tn, detection of the motion vector with respect to the reference color image Ic1t0 makes the calculation cost high. Accordingly, the motions of the black-and-white images Ic2t1 to Ic2tn are regarded as equal to the motions of the color images Ic1t1 to Ic2tn, and motion vectors Wc1t0, c2t0 to Wc1t0, c2tn are calculated and output to the super-resolution processing section 38.

The super-resolution processing sections 37 and 38 are configured similarly to the above-described super-resolution processing section 36. Note that, for simplification of description, the super-resolution processing sections 37 and 38 use the reference numerals of the super-resolution processing section 36.

The super-resolution processing section 37 stores a high-resolution color image calculated by performing upsampling or inverse spatial filter processing on the color image Ic1t0, in the buffer 368 as an accumulated image Ic1s. Next, the accumulated image Ic1s in the buffer 368 is subjected to spatial filter processing and downsampling and supplied to the subtracting section 364 as an image Ic1sa.

The color image Ic1t1 is subjected to motion compensation by the compensating section 361 on the basis of the motion vector Wc1t0t1 detected by the motion detecting section 33 and is supplied to the subtracting section 364.

The subtracting section 364 calculates a difference image between an image Ic1t1a after motion compensation and the image Ic1sa that has undergone the spatial filter processing or downsampling. This difference image is added to the accumulated image Ic1s in the buffer 368 after being subjected to upsampling and inverse spatial filter processing, and the image after addition is accumulated in the buffer 368 as a new accumulated image Ic1s.

After that, similar processing is repeatedly performed up to the final color image Ic1tn for the plurality of frames, so that a difference image between the image Ic1tna after motion compensation and the image Ic1sa subjected to spatial filter processing and downsampling is calculated, and the accumulated image Ic1s in the buffer 368 is added to the image calculated by performing upsampling or inverse spatial filter processing on this difference image, so that the image after the addition is output to the super-resolution processing section 38 as a super-resolution image SRc1t0 from the super-resolution processing section 37.

While using the super-resolution image SRc1t0 supplied from the super-resolution processing section 37 as a reference, the super-resolution processing section 38 performs super-resolution processing by using a plurality of narrow angle-of-view images (monochrome images) Ic2t0 to Ic2tn acquired by the image pickup unit 21-2 having a narrower angle of view than the image pickup unit 21-1 within the range of angle of view of the image pickup unit 21-1 and motion vectors Wc1t0, c2t0 to Wc1t0, c2tn calculated by the registration vector calculating section 35.

### 2-4. Operation of Second Embodiment

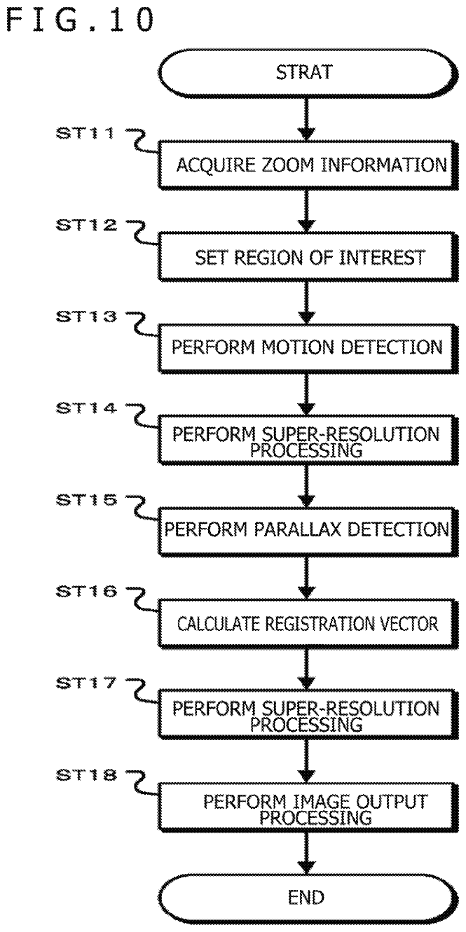

FIG. 10 is a flowchart depicting the operation of the signal processing unit according to the second embodiment. In step ST11, the signal processing unit acquires zoom information. The signal processing unit acquires the zoom information from the control unit 60 and proceeds to step ST12.

In step ST12, the signal processing unit sets a region of interest. The region-of-interest determining section 31-1 of the signal processing unit 30 determines the region of interest that is a region required for display in the wide angle-of-view color captured image acquired by the image pickup unit 21-1, on the basis of the zoom magnification indicated from the control unit 60. In addition, the region-of-interest determining section 31-2 determines the region of interest that is a region necessary for display in the plurality of frames of black-and-white captured images acquired by the image pickup unit 21-2, on the basis of the zoom magnification indicated from the control unit 60, and then, the processing proceeds to step ST13.

In step ST13, the signal processing unit performs motion detection. The motion detecting section 33 of the signal processing unit 30 detects the motion for each frame from the plurality of frames of color images of region of interest determined by the region-of-interest determining section 31-1 and the processing proceeds to step ST14.

In step ST14, the signal processing unit performs super-resolution processing. The super-resolution processing section 37 of the signal processing unit 30 performs addition feedback of the plurality of frames of color images and the like to generate a color image having a higher resolution than that of the color image acquired by the image pickup unit 21-1, and then, the processing proceeds to step ST15.

In step ST15, the signal processing unit performs parallax detection. The parallax detecting section 34 of the signal processing unit 30 detects the parallax of the image pickup unit 21-2 with respect to the image pickup unit 21-1 from the image of region of interest determined by the region-of-interest determining section 31-1 and the image of region of interest determined by the region-of-interest determining section 31-2. The parallax detecting section 34 detects the parallax on the basis of the color image Ic1t0 and the black-and-white image Ic2t0 of the region of interest, for example, and the processing proceeds to step ST15.

In step ST16, the signal processing unit calculates a registration vector. The registration vector calculating section 35 of the signal processing unit 30 calculates the motion vector of each frame while using the black and white images Ic2t0 to Ic2tn as the visual point of the image pickup unit 21-1, on the basis of the motion vector detected in step ST13 and the parallax detected in step ST15 and outputs the vector to the super-resolution processing section 38.

In step ST17, the signal processing unit performs super-resolution processing. The super-resolution processing section 38 of the signal processing unit 30 performs addition feedback and the like of the plurality of frames of monochrome images on the color image generated by the super-resolution processing of step ST14, and generates a higher-resolution color image than the color image generated in step ST14, and the processing proceeds to step ST18.

In step ST18, the signal processing unit performs image output processing. The super-resolution processing section 36 of the signal processing unit 30 outputs an image in the range of angle of view according to the zoom magnification set by the user or the like to the display unit 53, the storage unit 56, and the like, from the image generated in step ST17, on the basis of the zoom information from the control unit 60.

Note that the operation of the second embodiment is not limited to the step order depicted in FIG. 10, and for example, the processing of step ST14 and step ST17 may be performed after the processing of step ST15 and step ST16.

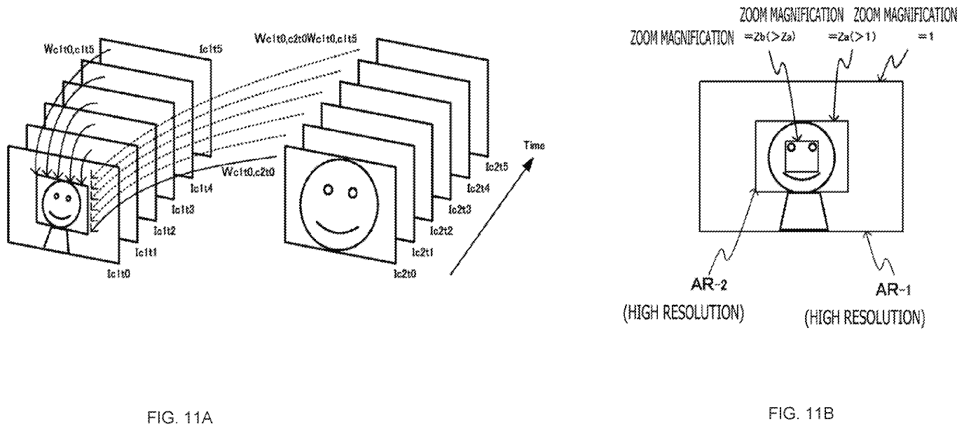

FIG. 11 depicts operation examples of the second embodiment. For the sake of simplifying the description, the region of interest is set to be the entire image. As depicted in a subfigure (a) of FIG. 11, the signal processing unit 30 performs super-resolution processing, with the color image Ic1t0 acquired by the image pickup unit 21-1 as a reference, for example, by using five color images Ic1t1 to Ic1t5 acquired by the image pickup unit 21-1 thereafter. Note that, in the super-resolution processing, position correction and addition feedback processing and the like of the color images Ic1t1 to Ic1t5 are performed on the basis of motion vectors Wc1t0, c1t1 to Wc1t0, c1t5 detected by the motion detecting section 33.

After that, the signal processing unit 30 performs super-resolution processing by using six monochrome images Ic2t0 to Ic2t5 acquired by the image pickup unit 21-2 with the color image Ic1t0 acquired by the image pickup unit 21-1 as a reference, for example. Note that in the super-resolution processing, position correction and addition feedback processing and the like of the monochrome images Ic2t0 to Ic2t5 are performed on the basis of motion vectors Wc1t0, c2t0 to Wc1t0, c2t5 calculated by the registration vector calculating section 35.

Accordingly, the imaging area AR-1 of the image pickup unit 21-1 and the imaging area AR-2 of the image pickup unit 21-2 have high resolution. Therefore, as depicted in a subfigure (b) of FIG. 11, a high-resolution color image can be output regardless of the zoom magnification, and the zoom operation can be performed seamlessly from a wide-angle view to a telephoto view without degrading the image quality.

Hence, according to the second embodiment, the zoom operation can be performed seamlessly from a wide-angle view to a telephoto view without degrading the image quality, as in the first embodiment.

Further, since the registration vector calculating section 35 calculates the registration vector on the assumption that the motions of the image pickup unit 21-2 and the image pickup unit 21-1 are equal, the calculation cost can be reduced as compared with the case where the motion is detected individually for the image pickup unit 21-2 and the image pickup unit 21-1.

Further, in the second embodiment, although the case where the super-resolution processing is performed using a plurality of frames of monochrome images after the super-resolution processing is performed using a plurality of frames of color images is exemplified, the super-resolution processing is not limited to the above order. For example, the super-resolution processing may be performed using a color image and a monochrome image according to the order of the frames.

### 2-5. Third Embodiment

Next, a third embodiment will be described. In the third embodiment, an MTF (Modulation Transfer Function) lens that is less affected by aliasing distortion is used in an image pickup unit that does not acquire a plurality of images used for super-resolution processing. Further, in the image pickup unit that acquires a plurality of images used for the super-resolution processing, a lens having a higher MTF is used than the image pickup unit that does not acquire the plurality of images, and a high-resolution image that is not affected by aliasing distortion is generated by the super-resolution processing.

For example, in the first embodiment, since the super-resolution processing is performed using the black and white images Ic2t0 to Ic2tn for the plurality of frames, the image pickup unit 21-2 that generates the black-and-white images Ic2t0 to Ic2tn uses a lens with a high MTF. Further, the image pickup unit 21-1 that generates the color image Ic1t0 uses a lens having a lower MTF than the image pickup unit 21-2 such that the influence of aliasing distortion is small.

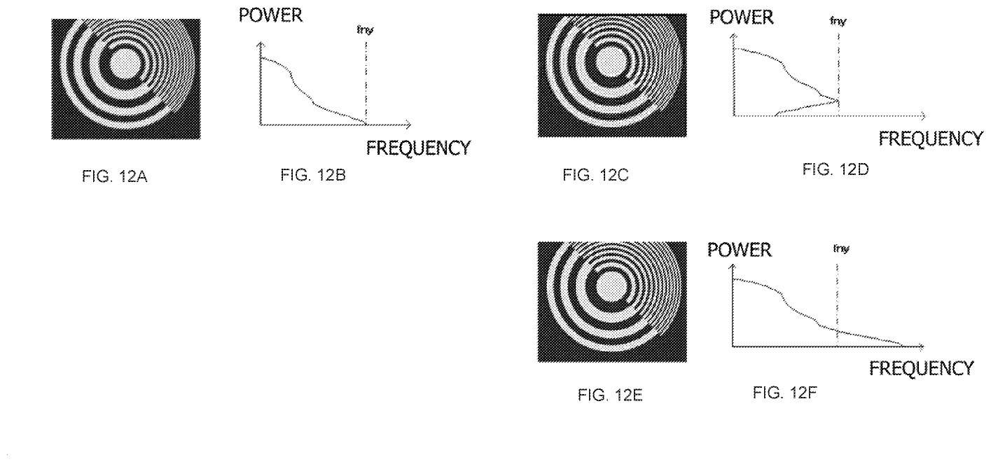

FIG. 12 illustrates the spectral distribution. The image pickup unit 21-1 uses a lens having a low MTF such that the influence of aliasing distortion is small. Therefore, the image acquired by the image pickup unit 21-1 is an image in which aliasing distortion is not noticeable, as depicted in a subfigure (a) of FIG. 12. Note that a subfigure (b) of FIG. 12 illustrates the spectral distribution of the lens used in the image pickup unit 21-1 and does not have a component with a frequency higher than the Nyquist frequency. Incidentally, the Nyquist frequency is determined by the pixel size of the image sensor used in the image pickup unit.

The image pickup unit 21-2 uses a lens having a higher MTF than the image pickup unit 21-1. Therefore, the image acquired by the image pickup unit 21-2 is an image in which aliasing distortion has occurred, as depicted in a subfigure (c) of FIG. 12. Note that a subfigure (d) of FIG. 12 illustrates the spectral distribution of the lens used in the image pickup unit 21-2, which has a frequency component higher than the Nyquist frequency. Here, if a plurality of images that has moved differently from the pixel unit is aligned and added by the super-resolution processing, an image in which aliasing distortion is removed is obtained as depicted in a subfigure (e) of FIG. 12. Note that a subfigure (f) of FIG. 12 illustrates the spectrum distribution after the super-resolution processing.

Further, in the second embodiment, a lens having a high MTF may be used not only in the image pickup unit 21-2 but also in the image pickup unit 21-1.

In this way, when a lens with a high MTF is used in the image pickup unit that acquires a plurality of images used for super-resolution processing, a color image with high resolution can be obtained as compared with the case where a lens with a low MTF is used.

Further, for separating a lens that is less affected by the aliasing distortion and a lens for generating the plurality of images to be used for the super-resolution processing, it is only required to use the result of comparison with the threshold value set for the MTF, for example. Here, the threshold value is set to a predetermined multiplying factor of the Nyquist frequency (for example, a value larger than the Nyquist frequency and smaller than the double thereof, preferably approximately 1.3 to 1.5 times).

### 2-6. Other Embodiments

Meanwhile, the processing cost becomes high in the case where super-resolution processing is performed by using a plurality of images to generate an image having a higher resolution than that of the plurality of images. Therefore, at the time of preview, an image in the range of angle of view corresponding to the zoom magnification is extracted from a wide angle-of-view color image. In addition, when an image is recorded or output to an external equipment or the like, super-resolution processing is performed to generate a high-resolution image, and an image having the range of angle of view corresponding to the zoom magnification is extracted from the high-resolution image. By doing so, the processing cost at the time of preview can be reduced.

### 3. Application Example

The technology according to the present disclosure can be applied to various products. For example, the technology according to the present disclosure is not limited to information processing terminals and thus may be achieved as a device mounted on any one type of mobile bodies such as automobiles, electric vehicles, hybrid electric vehicles, motorcycles, bicycles, personal mobility, airplanes, drones, ships, robots, construction machines, agricultural machines (tractors), etc.

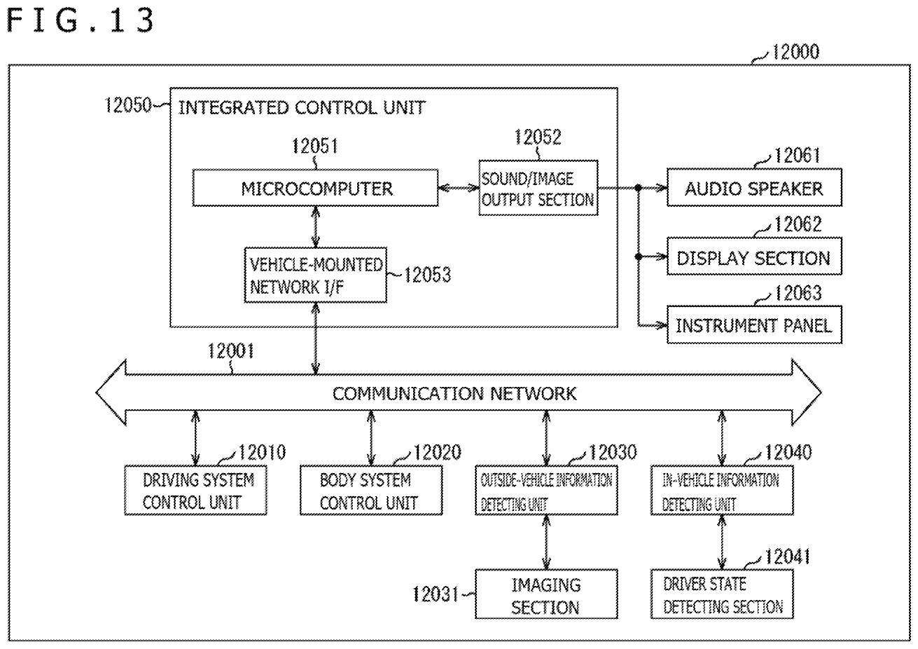

FIG. 13 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 13, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 13, an audio speaker 12061, a display section 12062, and an instrument panel 12063 are illustrated as the output device. The display section 12062 may, for example, include at least one of an on-board display and a head-up display.

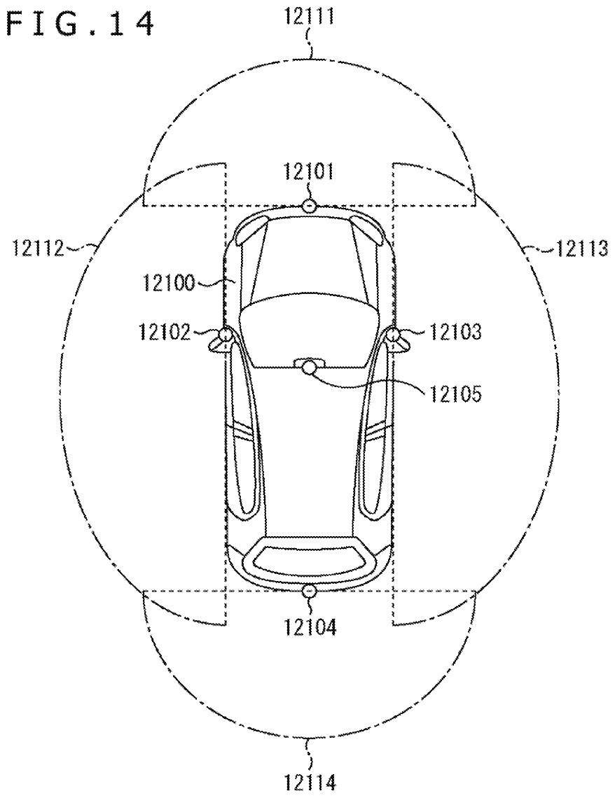

FIG. 14 is a diagram depicting an example of the installation position of the imaging section 12031.

In FIG. 14, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 14 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the vehicle control system 12000 described above, the imaging sections 12031, 12101, 12102, 12103, 12104, and 12105 are configured to use a plurality of image pickup units as necessary, for example, the image pickup units 21-1 and 21-2 depicted in FIG. 2. Further, the signal processing unit 30 is provided in the integrated control unit 12010 of the application example depicted in FIG. 13. With such a configuration, even when the imaging sections 12031, 12101, 12102, 12103, 12104, and 12105 are made small and thin, a high-quality and wide-angle-view captured image or zoom image can be obtained, and thus, the obtained captured image can be used for driving support and driving control. Note that the signal processing unit 30 may be achieved in a module (for example, an integrated circuit module configured by one die) for the integrated control unit 12010 depicted in FIG. 13.

The series of processes described in the specification can be executed by hardware, software, or a combined configuration of both. In the case of executing the processes by software, a program having recorded a processing sequence therein is installed in a memory in a computer incorporated in dedicated hardware and executed. Alternatively, the program can be installed and executed in a general-purpose computer that can execute various processes.

For example, the program can be recorded in advance in a hard disk, an SSD (Solid State Drive), or a ROM (Read Only Memory) as a recording medium. Alternatively, the program can be stored (recorded) temporarily or permanently in a removable recording medium such as a flexible disk, a CD-ROM (Compact Disc Read Only Memory), an MO (Magneto optical) disc, a DVD (Digital Versatile Disc), a BD (Blu-Ray Disc (registered trademark)), a magnetic disc, a semiconductor memory card. Such a removable recording medium can be provided as so-called package software.

Further, in addition to installing the program from the removable recording medium into the computer, the program may be transferred wirelessly or by wire from a download site to the computer via a network such as a LAN (Local Area Network) or the Internet. In the computer, the program thus transferred is received and can be installed in a recording medium such as a built-in hard disk.

It should be noted that the effects described in the present specification are merely examples and the effect is not limited thereto, and there may be additional effects not described. Further, the present technology should not be construed as being limited to the above-described embodiments of the technology. The embodiments of this technology disclose the present technology in the form of exemplification, and it is obvious that those skilled in the art can modify or substitute the embodiments without departing from the gist of the present technology. That is, in order to determine the gist of the present technology, the claims should be taken into consideration.

Further, the image processing device of the present technology can also have the following configurations.

(1) An image processing device including:

a signal processing unit that performs super-resolution processing using a plurality of narrow angle-of-view images having a narrow angle of view within a range of an angle of view of a wide angle-of-view image, with the wide angle-of-view image as a reference.

(2) The image processing device described in item (1), in which

the signal processing unit takes out an image in a range of an angle of view corresponding to a zoom magnification from an image subjected to the super-resolution processing.

(3) The image processing device described in item (2), in which

the signal processing unit sets a region of interest in each of the wide angle-of-view image and the narrow angle-of-view image according to the zoom magnification, and performs the super-resolution processing by using an image of the region of interest.

(4) The image processing device described in item (2) or (3), in which

the signal processing unit takes out the image in the range of the angle of view corresponding to the zoom magnification from the wide angle-of-view image at a time of preview.

(5) The image processing device described in any one of item (1) or (4), in which

the signal processing unit performs detection of a parallax from the wide angle-of-view image and the narrow angle-of-view image which are acquired simultaneously, and performs motion detection of the plurality of narrow angle-of-view images, so as to perform parallax compensation and motion compensation on the plurality of narrow angle-of-view images according to the parallax and a result of the motion detection in the super-resolution processing.

(6) The image processing device described in any one of items (1) to (5), in which

the signal processing unit uses a plurality of the wide angle-of-view images in the super-resolution processing.

(7) The image processing device described in item (6), in which

the signal processing unit performs detection of a parallax from the wide angle-of-view image and the narrow angle-of-view image which are acquired simultaneously, and performs motion detection of the plurality of the wide angle-of-view images, so as to perform parallax compensation and motion compensation on the plurality of narrow angle-of-view images according to a result of the detection, and to perform the motion compensation on the plurality of the wide angle-of-view images according to the result of the detection, regarding a motion of the plurality of narrow angle-of-view images as a motion of the wide angle-of-view image at a same time, in the super-resolution processing.

(8) The image processing device described in any one of items (1) to (7), in which

the plurality of narrow angle-of-view images is acquired by using a lens having a higher MTF (Modulation Transfer Function) than the wide angle-of-view image.

(9) The image processing device described in item (8), in which

a predetermined multiplying factor of Nyquist frequencies of an image pickup unit that acquires the narrow angle-of-view image and an image pickup unit that acquires the wide angle-of-view image is used as a threshold value, the wide angle-of-view image is acquired by using a lens having an MTF lower than the threshold value, and the narrow angle-of-view image is acquired by using a lens having an MTF which is the threshold value or higher.

(10) The image processing device described in any one of items (1) to (9), further including:

a first image pickup unit that acquires the wide angle-of-view image; and

a second image pickup unit that acquires the narrow angle-of-view image by using a lens having a higher MTF (Modulation Transfer Function) than the first image pickup unit.

(11) The image processing device described in any one of items (1) to (10), further including:

a control unit that controls the signal processing unit so as to select an image in a range of an angle of view corresponding to a zoom magnification indicated by a user operation from an image subjected to the super-resolution processing.

(12) The image processing device described in any one of items (1) to (11), in which

the wide angle-of-view image includes a color image, and the narrow angle-of-view image includes a black-and-white image.

### INDUSTRIAL APPLICABILITY

With the image processing device, image processing method, and program of this technology, super-resolution processing using a plurality of narrow-angle images having a narrow angle of view within the angle-of-view range of a wide angle-of-view image is performed with the wide angle-of-view image as a reference. Accordingly, a captured image that exceeds the performance of the image pickup unit can be acquired. Therefore, the technology is suitable for equipment that uses an image pickup unit and the like and that requires downsizing and thinning of the image pickup unit.

### REFERENCE SIGN LIST

10 . . . Information processing terminal
21-1, 21-2 . . . Image pickup unit
30 . . . Signal processing unit
31-1, 31-2 . . . Region-of-interest determining section
32 . . . Parallax/motion vector detecting section
33 . . . Motion detecting section
34 . . . Parallax detecting section
35 . . . Registration vector calculating section
36, 37, 38 . . . Super-resolution processing section
51 . . . Sensor unit
52 . . . Communication unit
53 . . . Display unit
54 . . . Touch panel
55 . . . Operation unit
56 . . . Storage unit
60 . . . Control unit
361 . . . Compensating section
362 . . . Spatial filter
363 . . . Downsampling section
364 . . . Subtracting section
365 . . . Upsampling section
366 . . . Inverse spatial filter
367 . . . Adding section
368 . . . Buffer
369 . . . Image output section

1. An image processing device comprising:
a signal processing unit that performs super-resolution processing using a plurality of narrow angle-of-view images having a narrow angle of view within a range of an angle of view of a wide angle-of-view image, with the wide angle-of-view image as a reference.

2. The image processing device according to claim 1, wherein
the signal processing unit takes out an image in a range of an angle of view corresponding to a zoom magnification from an image subjected to the super-resolution processing.

3. The image processing device according to claim 2, wherein
the signal processing unit sets a region of interest in each of the wide angle-of-view image and the narrow angle-of-view image according to the zoom magnification, and performs the super-resolution processing by using an image of the region of interest.

4. The image processing device according to claim 2, wherein
the signal processing unit takes out the image in the range of the angle of view corresponding to the zoom magnification from the wide angle-of-view image at a time of preview.

5. The image processing device according to claim 1, wherein
the signal processing unit performs detection of a parallax from the wide angle-of-view image and the narrow angle-of-view image which are acquired simultaneously, and performs motion detection of the plurality of narrow angle-of-view images, so as to perform parallax compensation and motion compensation on the plurality of narrow angle-of-view images according to the parallax and a result of the motion detection in the super-resolution processing.

6. The image processing device according to claim 1, wherein
the signal processing unit uses a plurality of the wide angle-of-view images in the super-resolution processing.

7. The image processing device according to claim 6, wherein
the signal processing unit performs detection of a parallax from the wide angle-of-view image and the narrow angle-of-view image which are acquired simultaneously, and performs motion detection of the plurality of the wide angle-of-view images, so as to perform parallax compensation and motion compensation on the plurality of narrow angle-of-view images according to a result of the detection, and to perform the motion compensation on the plurality of the wide angle-of-view images according to the result of the detection, regarding a motion of the plurality of narrow angle-of-view images as a motion of the wide angle-of-view image at a same time, in the super-resolution processing.

8. The image processing device according to claim 1, wherein
the plurality of narrow angle-of-view images is acquired by using a lens having a higher MTF (Modulation Transfer Function) than the wide angle-of-view image.

9. The image processing device according to claim 8, wherein
a predetermined multiplying factor of Nyquist frequencies of an image pickup unit that acquires the narrow angle-of-view image and an image pickup unit that acquires the wide angle-of-view image is used as a threshold value, the wide angle-of-view image is acquired by using a lens having an MTF lower than the threshold value, and the narrow angle-of-view image is acquired by using a lens having an MTF which is the threshold value or higher.

10. The image processing device according to claim 1, further comprising:
a first image pickup unit that acquires the wide angle-of-view image; and
a second image pickup unit that acquires the narrow angle-of-view image by using a lens having a higher MTF (Modulation Transfer Function) than the first image pickup unit.

11. The image processing device according to claim 1, further comprising:
a control unit that controls the signal processing unit so as to select an image in a range of an angle of view corresponding to a zoom magnification indicated by a user operation from an image subjected to the super-resolution processing.

12. The image processing device according to claim 1, wherein
the wide angle-of-view image includes a color image, and the narrow angle-of-view image includes a black-and-white image.

13. A method of processing an image, comprising:
performing super-resolution processing using a plurality of narrow angle-of-view images that have an angle of view which is narrower than that of a wide angle-of-view image and within a range of an angle of view of the wide angle-of-view image, with the wide angle-of-view image as a reference, by using a signal processing unit.

14. A program that causes a computer to execute processing of an image generated by an image pickup unit, the processing comprising:
acquiring a wide angle-of-view image; and
performing super-resolution processing using a plurality of narrow angle-of-view images that have an angle of view which is narrower than that of the wide angle-of-view image and within a range of an angle of view of the wide angle-of-view image, with the wide angle-of-view image as a reference.
